(19) United States
(12) Patent Application Publication
(10) Pub. No.: US 2004/0083468 A1
(43) Pub. Date: Apr. 29, 2004

(54) Instruction scheduling method, instruction scheduling device, and instruction scheduling program

(76) Inventors: Hajime Ogawa, Osaka (JP); Taketo Heishi, Osaka (JP); Shuichi Takayama, Takarazuka-shi (JP); Toshiyuki Sakata, Osaka (JP); Shohei Michimoto, Osaka (JP)

Correspondence Address: MCDERMOTT, WILL & EMERY, 600 13th Street, N.W., Washington, DC, 20005-3096, US

(21) Appl. No.: 10/645,871

(22) Filed: Aug. 22, 2003

(30) Foreign Application Priority Data
Aug. 22, 2002 (JP) 2002-241877

(51) Int. Cl. G06F 9/45

(52) U.S. Cl. 717/151; 717/154

(57) ABSTRACT

A dependency analysis unit creates a dependency graph showing dependencies between instructions acquired from an assembler code generation unit. A precedence constraint rank calculation unit assigns predetermined weights to arcs in the graph, and adds up weights to calculate a precedence constraint rank of each instruction. When a predecessor and a successor having a dependency and an equal precedence constraint rank cannot be processed in parallel due to a resource constraint, a resource constraint evaluation unit raises the precedence constraint rank of the predecessor. A priority calculation unit sets the raised precedence constraint rank as a priority of the predecessor. An instruction selection unit selects an instruction having a highest priority. An execution timing decision unit places the selected instruction in a clock cycle. The selection by the instruction selection unit and the placement by the execution timing decision unit are repeated until all instructions are placed in clock cycles.

This application is based on an application No. 2002-241877 filed in Japan, the contents of which are hereby incorporated by reference.

### BACKGROUND OF THE INVENTION

1. Field of the Invention

The present invention relates to an instruction scheduling method and an instruction scheduling device. The invention in particular relates to techniques of scheduling instructions in consideration of constraints of hardware resources used for processing the instructions.

2. Related Art

In general, an instruction scheduling device is equipped in a compiler device for parallel processors. The instruction scheduling device decides an appropriate execution timing of each of a plurality of instructions included in a compiled program and orders the instructions according to the decided execution timings, to thereby generate an object program optimized for parallel processing.

One conventional type of instruction scheduling device sequentially decides appropriate execution timings of individual instructions using a method called list scheduling. List scheduling is conducted as follows. For each instruction in an input program, a priority that indicates a position of the instruction in an order in which execution timings of instructions are decided is calculated based solely on dependencies between instructions. After this, an instruction having a highest priority is selected from instructions whose execution timings have not been decided, and an execution timing of the selected instruction is decided. The selection and decision are repeated until the execution timings of all instructions are decided.

In this specification, a priority used in the conventional technique, i.e., a priority based solely on dependencies between instructions, is referred to as a “precedence constraint rank”, to distinguish it from a priority specific to the present invention.

A dependency is a relation between instructions which are to be processed by the same hardware resource. Conventionally, dependencies are classified into the following three types: data dependency in which a resource defined by a preceding instruction (a predecessor) in an input program is referenced by a succeeding instruction (a successor) in the input program; anti-dependency in which a resource referenced by a predecessor is defined by a successor; and output dependency in which a resource defined by a predecessor is further defined by a successor.

If the execution order of instructions having such dependencies is disturbed, the execution result of the program may end up being wrong. Therefore, the instruction scheduling device decides the execution timings of the instructions so as to preserve the execution order of the instructions having dependencies.

FIG. 14 is a flowchart showing an example instruction scheduling procedure performed by the above conventional instruction scheduling device. This procedure has three main steps: a dependency graph creation step S910; a priority calculation step S920; and an execution timing decision step S930.

### Dependency Graph Creation Step S910

First, the conventional instruction scheduling device creates a dependency graph that shows dependencies between instructions included in an input program. The dependency graph is a directed acyclic graph. The graph has nodes which correspond to the individual instructions in the input program, and arcs which each connect two nodes corresponding to a predecessor and a successor having a dependency.

FIG. 15 shows an example program input to the conventional instruction scheduling device.

FIG. 16 shows a dependency graph created by the conventional instruction scheduling device for the input program shown in FIG. 15.

### Priority Calculation Step S920

The conventional instruction scheduling device then calculates a precedence constraint rank of each instruction. For instance, if the instruction has no successor with which it has a dependency, the precedence constraint rank of the instruction is 1. If the instruction has one or more successors with which it has anti-dependency or output dependency but not data dependency, the precedence constraint rank of the instruction is a highest one of precedence constraint ranks of these successors. If the instruction has one or more successors with which it has data dependency, the precedence constraint rank of the instruction is a sum of 1 and a highest one of precedence constraint ranks of these successors.

In more detail, the precedence constraint rank of each instruction is calculated in the following manner. First, weights 1, 0, and 0 are assigned respectively to arcs representing data dependency, anti-dependency, and output dependency in the dependency graph. Following this, the precedence constraint rank of each node is calculated by finding a sum of weights assigned to arcs along a path from the node to a terminal node and adding 1 to the sum. If there are a plurality of paths from the node to terminal nodes, a largest one of a plurality of values calculated for the plurality of paths is set as the precedence constraint rank of the node.

In the dependency graph shown in FIG. 16, the weights assigned to the arcs and the precedence constraint ranks calculated for the nodes are shown next to the corresponding arcs and nodes.

A precedence constraint rank of a node indicates a lower limit to a time period required for executing an instruction corresponding to the node and subsequent instructions, with the latencies between instructions having data dependency, anti-dependency, and output dependency being set respectively at 1, 0, and 0. A path that begins with a node having a highest precedence constraint rank is called a critical path. It is expected that the execution time period of all instructions can be shortened by executing the beginning instruction of the critical path as early as possible.

### Execution Timing Decision Step S930

To preserve the execution order of instructions having dependencies, the conventional instruction scheduling device subjects an instruction that satisfies one of the following conditions (a) and (b), to execution timing decision.

(a) The instruction has no predecessor with which it has a dependency.

(b) The instruction has one or more predecessors with which it has a dependency, but the execution timings of all of these predecessors have already been decided.

The conventional instruction scheduling device judges, for each instruction, whether the instruction satisfies one of the conditions (a) and (b). The conventional instruction scheduling device then selects an instruction having a highest precedence constraint rank (which is initially the beginning instruction of the critical path) among instructions that satisfy one of the conditions (a) and (b), and decides an execution timing of the selected instruction. This is repeated until execution timings of all instructions are decided.

Here, the execution timing of the instruction is decided as a clock cycle in which the instruction should be executed. In this specification, therefore, deciding an execution timing of an instruction is also referred to as placing the instruction in a clock cycle. Also, an instruction that satisfies one of the above conditions (a) and (b) is referred to as a “placeable instruction”.

The conventional instruction scheduling device places the selected instruction in a clock cycle that meets the following conditions (1) and (2).

(1) The clock cycle is the same as or later than a clock cycle in that a predecessor with which the instruction has anti-dependency or output dependency is placed, and is later than a clock cycle in that a predecessor with which the instruction has data dependency is placed.

(2) The clock cycle is an earliest clock cycle in that a hardware resource can process the instruction.

Thus, the conventional instruction scheduling device places the beginning instruction of the critical path in an earliest clock cycle possible before placing the other instructions, when there are still many clock cycles in which instructions can be placed. In this way, the conventional instruction scheduling device places all instructions in as few clock cycles as possible, without affecting the execution result of the program.

FIG. 17 shows how the instructions of the program shown in FIG. 15 are placed in clock cycles, when the target processor has an instruction decoder capable of processing two instructions in parallel in one clock cycle, an arithmetic unit capable of processing two instructions in parallel in one clock cycle, and a memory access unit capable of processing one instruction in one clock cycle. In the drawing, a clock cycle field 901 shows a clock cycle by a relative number. An instruction 1 field 902 and an instruction 2 field 903 each show an instruction placed in the clock cycle, together with a position of the instruction in an order in which the instructions are placed in the clock cycles (i.e., an order in which the execution timings of the instructions are decided).

Here, instructions F and G are to be processed by the memory access unit that is capable of processing only one instruction in one clock cycle, and so cannot be processed in the same clock cycle. Accordingly, instructions F and G are placed in separate clock cycles 4 and 5. Which is to say, only instruction F is placed in clock cycle 4.

The conventional compiler device sequences such placed instructions in the clock cycle order, and attaches boundary information showing a boundary of clock cycles to the last instruction of each clock cycle. Hence an object program optimized for parallel processing is obtained. Here, the boundary information is expressed, for instance, as 1-bit flag information. The target processor executes an instruction having boundary information and the next instruction, in separate clock cycles.

In the example shown in FIG. 17, instructions A to G are output in the order shown in FIG. 15, with boundary information being attached to instructions A, C, E, F, and G.

It is expected that such an object program optimized for parallel processing is executed by the target processor in fewer clock cycles than a program not optimized for parallel processing.

According to the above conventional technique, however, there are cases where instructions are not placed in as few clock cycles as possible. In other words, the conventional technique fails to sufficiently optimize a program for parallel processing.

Take the program shown in FIG. 15 as one example. Suppose instruction E is selected and placed in clock cycle 2 in the second decision. This allows instructions F and G to be placed respectively in clock cycles 3 and 4 and instructions B, C, and D to be placed respectively in clock cycles 2, 3, and 4. As a result, instructions A to G can be placed in four clock cycles (see FIG. 5).

According to the conventional technique, however, instructions are selected in an order of precedence constraint ranks that are calculated based solely on dependencies between instructions. Accordingly, there is no possibility that instruction E is selected in the second decision. Hence it is impossible to sufficiently optimize the program in the above way.

### SUMMARY OF THE INVENTION

In view of the above problem, the present invention aims to provide an instruction scheduling method and instruction scheduling device that enable instructions to be placed in fewer clock cycles than in the conventional technique.

The stated object can be achieved by an instruction scheduling method including: a priority calculation step of calculating a priority of each of a plurality of instructions that are subjected to scheduling, based on dependencies between the plurality of instructions and constraints of hardware resources for processing the plurality of instructions, the dependencies being data dependency, anti-dependency, and output dependency; and an execution timing decision step of deciding an execution timing of an instruction having a highest priority.

According to this method, instructions are selected and placed in clock cycles according to priorities that are calculated based on constraints of hardware resources. This allows an instruction having a strict resource constraint to be placed in an earlier clock cycle. Hence a plurality of instructions including such an instruction can be placed in fewer clock cycles than in the conventional technique.

Here, the priority calculation step may include: a precedence constraint rank calculation substep of calculating a precedence constraint rank of each of the plurality of instructions, wherein (a) if the instruction has a succeeding instruction which is anti-dependent or output dependent on the instruction, the precedence constraint rank of the instruction is equal to a precedence constraint rank of the succeeding instruction, and (b) if the instruction has a succeeding instruction which is data dependent on the instruction, the precedence constraint rank of the instruction is higher than a precedence constraint rank of the succeeding instruction; and a resource constraint evaluation substep of judging (i) whether the instruction has a succeeding instruction which is dependent on the instruction, (ii) whether the instruction and the succeeding instruction have an equal precedence constraint rank, and (iii) whether a hardware resource for processing the instruction cannot process the instruction and the succeeding instruction in parallel, and the priority calculation step raises the precedence constraint rank of the instruction and sets the raised precedence constraint rank as a priority of the instruction if all of the judgments (i), (ii), and (iii) are in the affirmative, and sets the precedence constraint rank of the instruction as the priority of the instruction if any of the judgments (i), (ii), and (iii) is in the negative.

According to this method, when a predecessor and a successor that have a dependency and an equal precedence constraint rank cannot be processed in parallel by a hardware resource in a target processor, the priority of the predecessor is set higher than the precedence constraint rank of the predecessor. This makes it possible to find a new critical path generated by resource constraints, which has been overlooked by the conventional technique. The beginning instruction of this critical path is placed in an earliest clock cycle possible. Hence a plurality of instructions including instructions that cannot be processed in parallel due to resource constraints can be placed in fewer clock cycles than in the conventional technique.

Here, the priority calculation step may include: a precedence constraint rank calculation substep of calculating a precedence constraint rank of each of the plurality of instructions, wherein (a) if the instruction has no succeeding instruction which is dependent on the instruction, the precedence constraint rank of the instruction is 1, (b) if the instruction has one or more succeeding instructions which are anti-dependent or output dependent on the instruction, the precedence constraint rank of the instruction is a highest one of precedence constraint ranks of the succeeding instructions, and (c) if the instruction has one or more succeeding instructions which are data dependent on the instruction, the precedence constraint rank of the instruction is a sum of 1 and a highest one of precedence constraint ranks of the succeeding instructions; and a resource constraint evaluation substep of calculating a resource constraint value of the instruction, by dividing a total number of instructions which are to be processed by a hardware resource for processing the instruction and whose execution timings have not been decided, by a maximum number of instructions that can be processed in parallel by the hardware resource, and the priority calculation step sets the resource constraint value as a priority of the instruction if the resource constraint value is larger than the precedence constraint rank, and sets the precedence constraint rank as the priority of the instruction if the resource constraint value is no larger than the precedence constraint rank.

According to this method, a higher one of a resource constraint value and a precedence constraint rank is set as the priority of each instruction. This allows an instruction having a strict resource constraint to be placed in an earlier clock cycle than in the conventional technique. Hence a plurality of instructions including such an instruction can be placed in fewer clock cycles than in the conventional technique.

Especially when there are many unplaced instructions which are to be processed by a hardware resource that can process only a small number of instructions in parallel and no dependencies exist between these instructions, high resource constraint values are calculated for such instructions. This produces a specific effect of appropriately placing such instructions in earlier clock cycles.

The stated object can also be achieved by an instruction scheduling method for sequentially deciding execution timings of instructions that are subjected to scheduling, including: a decision judgment step of judging, after an execution timing of a first instruction is decided, whether an execution timing of a second instruction can be decided so as to be within a predetermined time period, based on a constraint of a hardware resource for processing the second instruction; and a redecision step of retracting, if the judgment is in the negative, the decision of the execution timing of the first instruction and deciding an execution timing of an instruction other than the first instruction.

Here, the predetermined time period may be expressed by a number of clock cycles, wherein the decision judgment step includes: a resource constraint evaluation substep of calculating a resource constraint value of the second instruction, by dividing a total number of instructions which are to be processed by the hardware resource and whose execution timings have not been decided, by a maximum number of instructions that can be processed in parallel by the hardware resource, and the decision judgment step judges in the negative if the resource constraint value is larger than the number of clock cycles.

According to these methods, it is judged in consideration of resource constraints whether all instructions can be placed within a predetermined number of clock cycles. If the judgment is in the negative, the immediately preceding placement is retracted and another instruction is placed in a clock cycle. This contributes to a greater chance of placing instructions including strict resource-constraint instructions in a desired number of clock cycles, when compared with the case of making the same judgment in consideration of only dependencies between instructions.

The stated object can also be achieved by a program conversion method characterized in that: an input program is converted to an object program including a plurality of instructions, and an execution timing of each of the plurality of instructions in the object program is decided using the instruction scheduling method of one of claims 1 to 5.

According to this method, an instruction scheduling method having the aforementioned effects is applied to an intermediate program, with it being possible to produce an object program that is more highly optimized for parallel processing.

The stated object can also be achieved by an instruction scheduling device including: a priority calculation unit operable to calculate a priority of each of a plurality of instructions that are subjected to scheduling, based on dependencies between the plurality of instructions and constraints of hardware resources for processing the plurality of instructions, the dependencies being data dependency, anti-dependency, and output dependency; and an execution timing decision unit operable to decide an execution timing of an instruction having a highest priority.

The stated object can also be achieved by an instruction scheduling device for sequentially deciding execution timings of instructions that are subjected to scheduling, including: a decision judgment unit operable to judge, after an execution timing of a first instruction is decided, whether an execution timing of a second instruction can be decided so as to be within a predetermined time period, based on a constraint of a hardware resource for processing the second instruction; and a redecision unit operable to retract, if the judgment is in the negative, the decision of the execution timing of the first instruction and decide an execution timing of an instruction other than the first instruction.

According to these constructions, an instruction scheduling device having the aforementioned effects can be realized.

The stated object can also be achieved by a computer-executable program for instruction scheduling, having a computer execute: a priority calculation step of calculating a priority of each of a plurality of instructions that are subjected to scheduling, based on dependencies between the plurality of instructions and constraints of hardware resources for processing the plurality of instructions, the dependencies being data dependency, anti-dependency, and output dependency; and an execution timing decision step of deciding an execution timing of an instruction having a highest priority.

The stated object can also be achieved by a computer-executable program for sequentially deciding execution timings of instructions that are subjected to scheduling, having a computer execute: a decision judgment step of judging, after an execution timing of a first instruction is decided, whether an execution timing of a second instruction can be decided so as to be within a predetermined time period, based on a constraint of a hardware resource for processing the second instruction; and a redecision step of retracting, if the judgment is in the negative, the decision of the execution timing of the first instruction and deciding an execution timing of an instruction other than the first instruction.

According to these programs, instruction scheduling processing having the aforementioned effects can be achieved on a computer.

The stated object can also be achieved by a computer-readable storage medium storing the program of one of claims 9 and 10.

According to this storage medium, a program having the aforementioned effects can be distributed to a desired computer which may then execute the program.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a functional block diagram showing an overall construction of a compiler device to which the first embodiment of the invention relates;

FIG. 2 shows an example construction of a processor targeted by the compiler device shown in FIG. 1;

FIG. 3 is a flowchart showing an instruction scheduling procedure in the first embodiment;

FIG. 4 shows an example dependency graph created by a dependency analysis unit shown in FIG. 1;

FIG. 5 shows an example of placing instructions in clock cycles;

FIG. 6 is a flowchart showing an instruction scheduling procedure in the second embodiment of the invention;

FIGS. 7 and 8 show an example instruction placement process;

FIG. 9 is a functional block diagram showing an overall construction of a compiler device to which the third embodiment of the invention relates;

FIG. 10 is a flowchart showing an instruction scheduling procedure in the third embodiment;

FIGS. 11 and 12 show an example instruction placement process;

FIG. 13 shows an example of placing instructions in clock cycles;

FIG. 14 is a flowchart showing an instruction scheduling procedure performed by a conventional device;

FIG. 15 shows an example program input to the conventional device;

FIG. 16 shows a dependency graph created by the conventional device for the input program shown in FIG. 15; and

FIG. 17 shows an example of placing instructions in clock cycles by the conventional device.

### DESCRIPTION OF THE PREFERRED EMBODIMENTS

### First Embodiment

An instruction scheduling device of the first embodiment of the present invention receives an input of a plurality of instructions that are subjected to scheduling, calculates a priority of each instruction based on dependencies between instructions and constraints of hardware resources, and selects and places the instructions according to the calculated priorities.

In more detail, for each instruction which has a successor with the same precedence constraint rank, the instruction scheduling device judges whether the instruction and the successor can be processed in parallel by a hardware resource in a target processor. If the judgment is in the negative, the instruction scheduling device raises the precedence constraint rank of the instruction and sets the raised precedence constraint rank as the priority of the instruction. For each of the other instructions, the instruction scheduling device sets the precedence constraint rank of the instruction as the priority of the instruction. After calculating the priority of each instruction in this way, the instruction scheduling device selects an unplaced instruction having a highest priority, and places the selected instruction in a clock cycle. This selection and placement are repeated until all instructions are placed in clock cycles.

This instruction scheduling device has the following feature. When a predecessor and a successor have the same precedence constraint rank but cannot be processed in parallel due to a constraint of a hardware resource, the instruction scheduling device sets the priority of the predecessor higher than the precedence constraint rank which is based solely on dependencies between instructions. This makes it possible to find a new critical path generated by resource constraints, which has been overlooked by the conventional technique.

The instruction scheduling device places the beginning instruction of such a critical path in an earliest clock cycle possible. In this way, a plurality of instructions including instructions that cannot be processed in parallel due to resource constraints can be placed in fewer clock cycles than in the conventional technique.

### Overall Construction

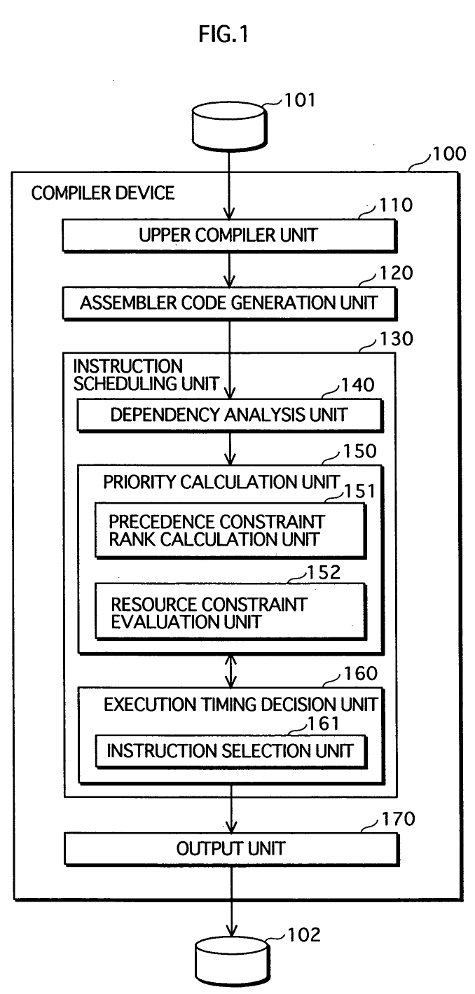

FIG. 1 is a functional block diagram showing an overall construction of a compiler device 100 to which the first embodiment relates. The compiler device 100 includes the instruction scheduling device of the first embodiment as an instruction scheduling unit 130.

The compiler device 100 acquires a source program from a source file 101, and compiles the source program. The compiler device 100 then generates an object program optimized for parallel processing from the compiled program, and outputs the object program to an object file 102.

The compiler device 100 includes an upper compiler unit 110, an assembler code generation unit 120, the instruction scheduling unit 130, and an output unit 170. The instruction scheduling unit 130 includes a dependency analysis unit 140, a priority calculation unit 150, and an execution timing decision unit 160. The priority calculation unit 150 includes a precedence constraint rank calculation unit 151 and a resource constraint evaluation unit 152. The execution timing decision unit 160 includes an instruction selection unit 161.

The compiler device 100 is actually realized by software and hardware including a processor, a ROM (Read Only Memory) storing a program, a working RAM (Random Access Memory), and a disk device. The functions of the individual components of the compiler device 100 are achieved by the processor executing the program stored in the ROM. Data transfers between the individual components are carried out through hardware such as the RAM and the disk device.

The upper compiler unit 110 reads a source program from the source file 101, and performs lexical analysis and syntax analysis to generate an intermediate code string.

The assembler code generation unit 120 generates an assembler code string from the intermediate code string generated by the upper compiler unit 110.

The instruction scheduling unit 130 calculates a priority of each instruction included in the assembler code string, based on a dependency with another instruction and a constraint of a hardware resource for processing the instruction. After this, the instruction scheduling unit 130 selects an instruction having a highest priority among unplaced instructions, and places the selected instruction in a clock cycle. The selection and placement are repeated until all instructions are placed in clock cycles. The instruction scheduling unit 130 is explained in more detail later.

The output unit 170 outputs the instructions together with boundary information mentioned in the description of the related art, in an order of clock cycles.

The following explains a construction of a processor targeted by the compiler device 100 and a detailed construction of the instruction scheduling unit 130.

### Target Processor

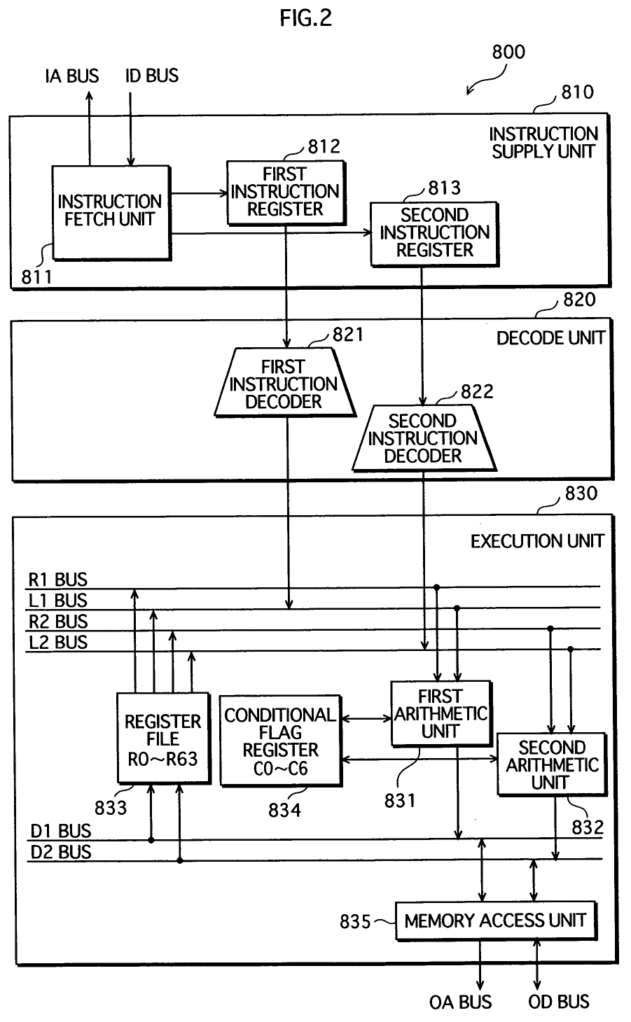

FIG. 2 is a functional block diagram showing an example construction of a processor 800 targeted by the compiler device 100. This drawing is intended to provide a specific example of constraints of hardware resources relevant to the present invention, and therefore only illustrates the relevant parts in simplified form.

The processor 800 is roughly made up of an instruction supply unit 810, a decode unit 820, and an execution unit 830.

The instruction supply unit 810 includes an instruction fetch unit 811, a first instruction register 812, and a second instruction register 813. The instruction fetch unit 811 fetches instructions from an external memory (not shown in the drawing) via an IA (Instruction Address) bus and an ID (Instruction Data) bus. The first instruction register 812 and the second instruction register 813 hold the fetched instructions. From the first instruction register 812 and the second instruction register 813, two instructions are supplied to the decoder unit 820 in parallel in one clock cycle.

The decoder unit 820 includes a first instruction decoder 821 and a second instruction decoder 822. The first instruction decoder 821 and the second instruction decoder 822 decode two instructions in parallel in one clock cycle, and supply control signals showing the decoding results to the execution unit 830.

The execution unit 830 operates according to the control signals supplied from the decode unit 820. The execution unit 830 includes a first arithmetic unit 831, a second arithmetic unit 832, a register file 833, a conditional flag register 834, and a memory access unit 835. The first arithmetic unit 831 and the second arithmetic unit 832 are each connected to the register file 833 via dedicated bus lines, and to the conditional flag register 834. The first arithmetic unit 831 and the second arithmetic unit 832 perform two operations relating to two instructions in parallel in one clock cycle. The memory access unit 835 performs one memory access relating to one instruction in one clock cycle, via an OA (Operand Address) bus and an OD (Operand Data) bus.

With the above construction, the processor 800 is capable of processing two instructions at the maximum in one clock cycle if the instructions are to be processed by the arithmetic units, and one instruction at the maximum in one clock cycle if the instruction is to be processed by the memory access unit. These are the constraints of the hardware resources in the processor 800.

### Instruction Scheduling Unit 130

The instruction scheduling unit 130 in the first embodiment is explained in detail below, with reference to a flowchart.

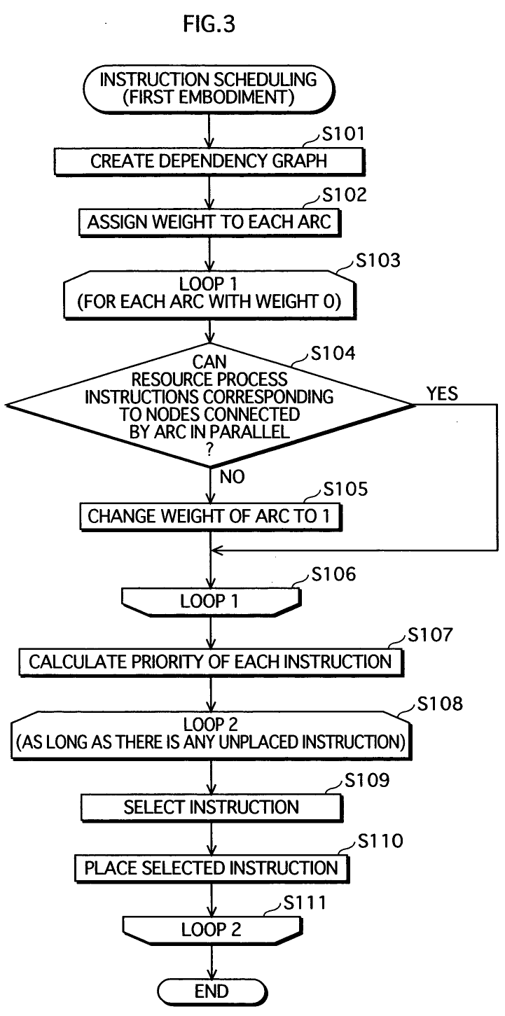

FIG. 3 is a flowchart showing an instruction scheduling procedure in the first embodiment.

(Step S101) The dependency analysis unit 140 creates a dependency graph showing dependencies between instructions included in an assembler code string generated by the assembler code generation unit 120, in the same way as in the conventional technique.

(Step S102) The precedence constraint rank calculation unit 151 assigns weights 1, 0, and 0 respectively to arcs representing data dependency, anti-dependency, and output dependency in the dependency graph created by the dependency analysis unit 140, in the same way as in the conventional technique.

(Step S103) Steps S104 to S106 are repeated for each arc having weight 0 (loop 1).

(Step S104) The resource constraint evaluation unit 152 judges whether a hardware resource can process two instructions in parallel which correspond to nodes connected by the arc, i.e., two instructions which have the same precedence constraint rank. If the judgment is in the negative, the procedure advances to step S105.

(Step S105) The resource constraint evaluation unit 152 changes the weight of the arc to 1.

(Step S106) The procedure returns to step S103.

(Step S107) After the loop 1 ends, the priority calculation unit 150 calculates, for each node in the dependency graph, a sum of weights of arcs along a path from the node to a terminal node. The priority calculation unit 150 then adds 1 to the sum to thereby calculate a priority of an instruction corresponding to the node. Here, the weight of each arc connecting two instructions that have the same precedence constraint rank but cannot be processed in parallel due to a resource constraint has been changed in step S105. Accordingly, if the path includes such an arc, the calculated priority of the instruction is higher than the precedence constraint rank of the instruction.

(Step S108) Steps S109 to S111 are repeated as long as there is an unplaced instruction (loop 2).

(Step S109) The instruction selection unit 161 selects an instruction having a highest priority among unplaced instructions.

(Step S110) The execution timing decision unit 160 places the selected instruction in a clock cycle that meets the following two conditions (1) and (2).

(1) The clock cycle is the same as or later than a clock cycle in that a predecessor with which the instruction has anti-dependency or output dependency is placed, and is later than a clock cycle in that a predecessor with which the instruction has data dependency is placed.

(2) The clock cycle is an earliest clock cycle in that a hardware resource can process the instruction.

(Step S111) The procedure returns to step S108.

### SPECIFIC EXAMPLE

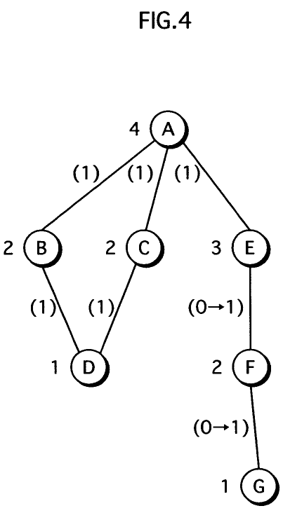

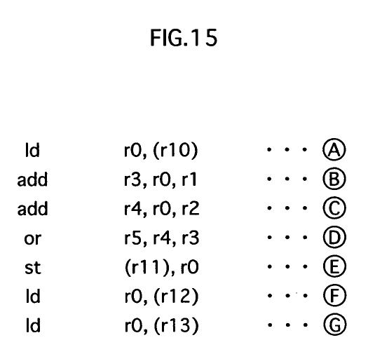

FIG. 4 shows a dependency graph created by the dependency analysis unit 140 for the program shown in FIG. 15. In the dependency graph, each value in parentheses denotes a weight assigned to an arc by the precedence constraint rank calculation unit 151.

A pair of instructions connected by each arc having weight 0, such as instructions E and F and instructions F and G, are instructions to be processed by the memory access unit. Accordingly, the resource constraint evaluation unit 152 judges that the pair of instructions cannot be processed in parallel in one clock cycle, and changes the weight of the arc to 1. This change is indicated as “(0→1)” in FIG. 4.

Following this, the priority calculation unit 150 adds up weights to calculate priorities. In FIG. 4, a value shown next to each node is such a calculated priority. For example, the priority of instruction A is 4, which is calculated by adding 1 to a sum of weights of arcs along path A-E-F-G.

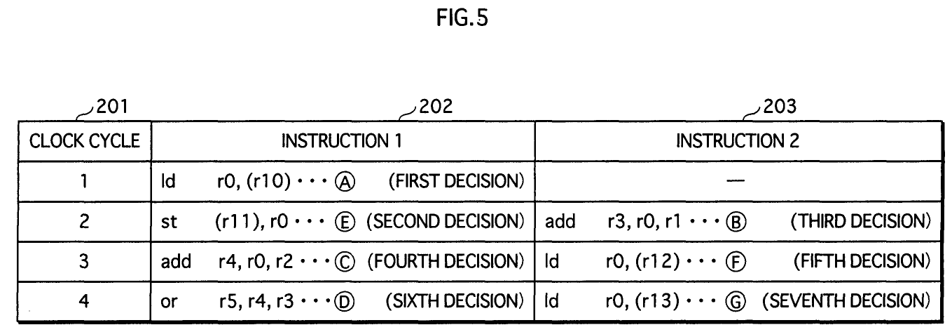

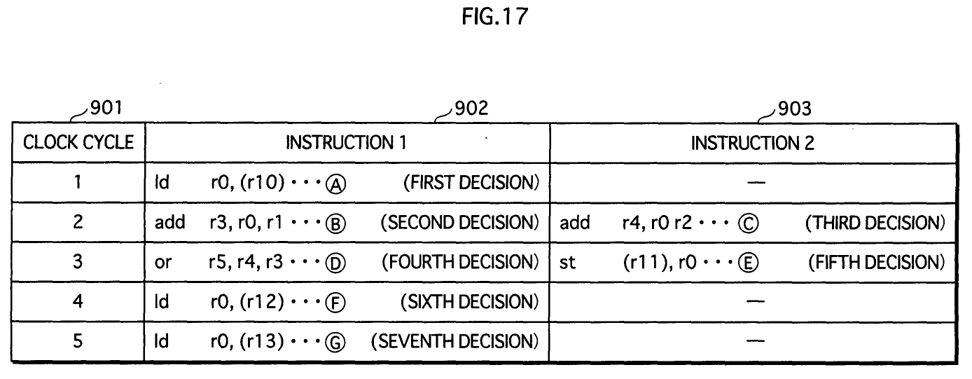

FIG. 5 shows instructions A to G which are placed in clock cycles according to the priorities calculated in the dependency graph shown in FIG. 4. The notation is the same as that of FIG. 17. Since the priority of instruction E is 3, instruction E is placed in clock cycle 2 in the second decision. As a result, instructions A to G are placed in four clock cycles which are one clock fewer than in the case of FIG. 17.

### Conclusion

As described above, when a predecessor and a successor have a dependency with the same precedence constraint rank but cannot be processed in parallel by a hardware resource in a target processor, the instruction scheduling device of the first embodiment sets the priority of the predecessor higher than the precedence constraint rank of the predecessor.

This makes it possible to find a new critical path generated by resource constraints, which has been overlooked by the conventional technique. The instruction scheduling device places the beginning instruction of the critical path in an earliest clock cycle possible. In this way, a plurality of instructions including instructions that cannot be processed in parallel due to resource constraints can be placed in fewer clock cycles than in the conventional technique.

### Second Embodiment

An instruction scheduling device of the second embodiment of the present invention receives an input of a plurality of instructions that are subjected to scheduling, and calculates a precedence constraint rank of each instruction. After this, the instruction scheduling device calculates a resource constraint value for each placeable instruction. There source constraint value is obtained by dividing a total number of unplaced instructions which are to be processed by a hardware resource for processing the instruction, by a maximum number of instructions which can be processed in parallel by the hardware resource. The instruction scheduling device sets a higher one of the precedence constraint rank and the resource constraint value, as a priority of the instruction. The instruction scheduling device then selects an instruction having a highest priority, and places the selected instruction in a clock cycle. This is repeated until all instructions are placed in clock cycles.

Here, the resource constraint value indicates a lower limit to a time period required to execute all unplaced instructions which are to be processed by the hardware resource.

The instruction scheduling device of the second embodiment differs from that of the first embodiment in that resource constraint values are calculated and in that priorities are calculated each time one instruction is placed in a clock cycle.

The following explanation mainly focuses on this difference from the first embodiment, while omitting the same features as those of the first embodiment.

### Overall Construction

A compiler device to which the second embodiment relates has the same-overall construction as the compiler device 100 in the first embodiment (see FIG. 1), and differs only in that the instruction scheduling device of the second embodiment is included as the instruction scheduling unit 130 instead of the instruction scheduling device of the first embodiment. Accordingly, an instruction scheduling procedure performed by the instruction scheduling unit 130 in the second embodiment is different from that in the first embodiment.

### Instruction Scheduling Unit 130

The instruction scheduling unit 130 in the second embodiment is explained in detail below, with reference to a flowchart.

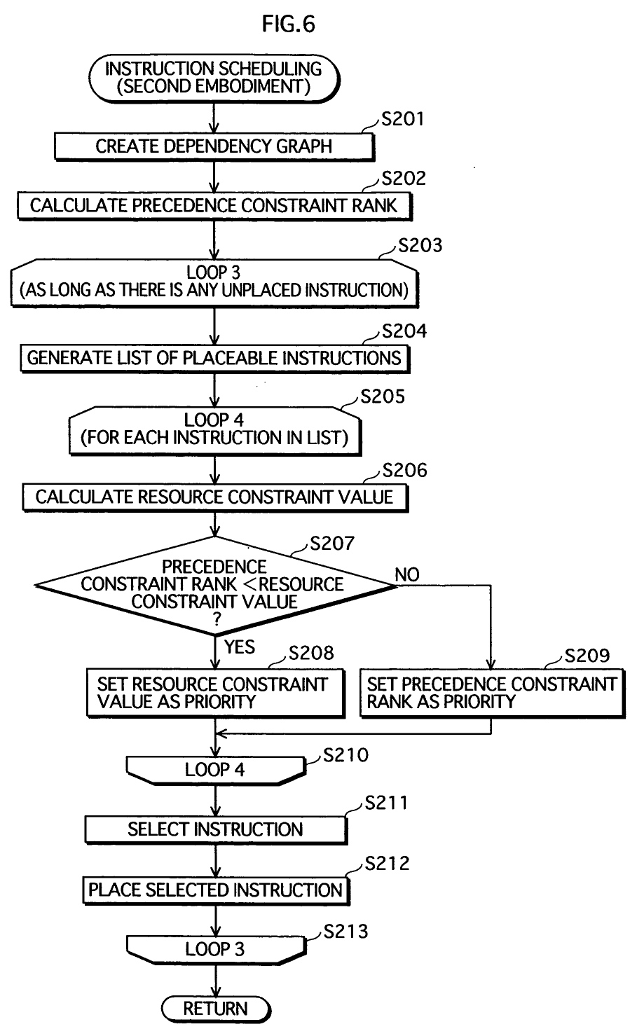

FIG. 6 is a flowchart showing the instruction scheduling procedure in the second embodiment.

(Step S201) The dependency analysis unit 140 creates a dependency graph showing dependencies between instructions included in an assembler code string generated by the assembler code generation unit 120.

(Step S202) The precedence constraint rank calculation unit 151 assigns weights 1, 0, and 0 respectively to arcs representing data dependency, anti-dependency, and output dependency in the dependency graph created by the dependency analysis unit 140. The precedence constraint rank calculation unit 151 then adds up weights to calculate precedence constraint ranks.

(Step S203) Steps S204 to S213 are repeated as long as there is an unplaced instruction (loop 3).

(Step S204) The instruction scheduling unit 130 generates a list of placeable instructions. A placeable instruction is an instruction that satisfies one of the following two conditions (a) and (b).

(a) The instruction has no predecessor with which it has a dependency.

(b) The instruction has one or more predecessors with which it has a dependency, but all of these predecessors have already been placed in clock cycles.

(Step S205) Steps S206 to S210 are repeated for each instruction in the list (loop 4).

(Step S206) The resource constraint evaluation unit 152 calculates a resource constraint value for the instruction. The resource constraint value is obtained by dividing a total number of unplaced instructions which are to be processed by a hardware resource for processing the instruction, by a maximum number of instructions which can be processed in parallel by the hardware resource.

(Step S207) If the resource constraint value of the instruction is larger than a precedence constraint rank of the instruction, the procedure advances to step S208. Otherwise, the procedure advances to step S209.

(Step S208) The resource constraint evaluation unit 152 sets the resource constraint value as a priority of the instruction.

(Step S209) The resource constraint evaluation unit 152 sets the precedence constraint rank as the priority of the instruction.

(Step S210) The procedure returns to step S205.

(Step S211) The instruction selection unit 161 selects an instruction having a highest priority among unplaced instructions.

(Step S212) The execution timing decision unit 160 places the selected instruction in a clock cycle that meets the following conditions (1) and (2).

(1) The clock cycle is the same as or later than a clock cycle in that a predecessor with which the instruction has anti-dependency or output dependency is placed, and is later than a clock cycle in that a predecessor with which the instruction has data dependency is placed.

(2) The clock cycle is an earliest clock cycle in that a hardware resource can process the instruction.

(Step S213) The procedure returns to step S203.

### SPECIFIC EXAMPLE

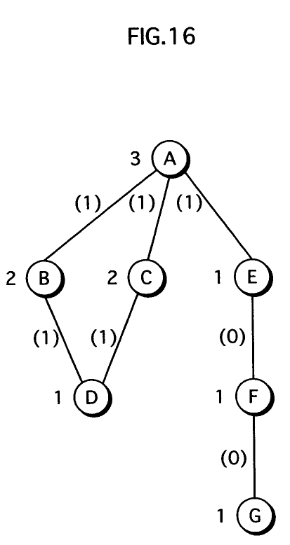

Take once again the program shown in FIG. 15 as an example. The dependency analysis unit 140 creates a dependency graph that is identical to the conventional dependency graph shown in FIG. 16. The precedence constraint rank calculation unit 151 calculates precedence constraint ranks from the dependency graph, in the same way as in the conventional technique.

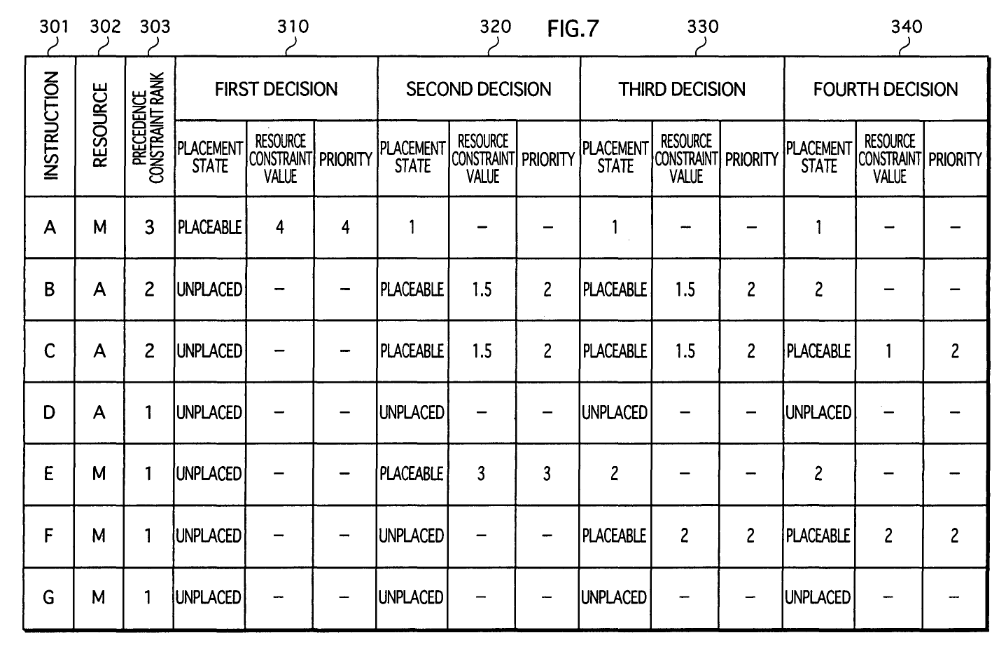

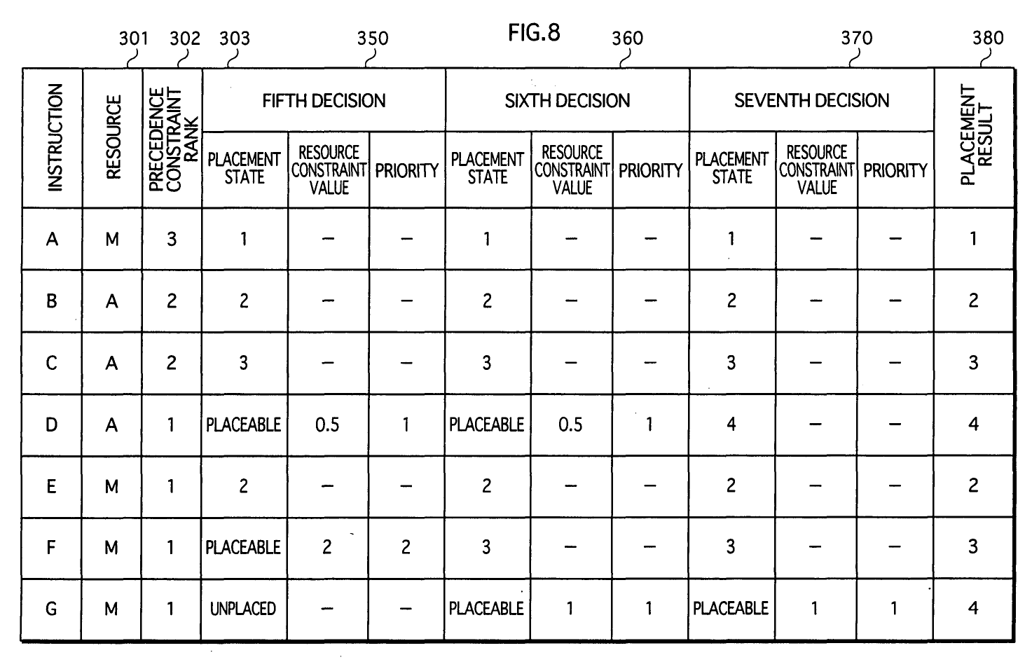

FIGS. 7 and 8 show a process of placing each of instructions A to G by the instruction scheduling unit 130.

In the drawing, an instruction field 301 shows an instruction by a letter symbol. A resource field 302 shows M when the instruction is to be processed by the memory access unit, and A when the instruction is to be processed by the arithmetic units. A precedence constraint rank field 303 shows a precedence constrain rank of the instruction.

First to seventh decision fields 310 to 370 each show a placement state, a resource constraint value, and a priority of the instruction, in an order in which execution timings of instructions A to G are decided. The placement state field has three states. When the instruction is unplaced and is not placeable, the placement state field shows “unplaced”. When the instruction is unplaced and is placeable, the placement state field shows “placeable”. When the instruction has already been placed, the placement state field shows a cycle number of a clock cycle in which the instruction is placed.

A placement result field 380 shows cycle numbers of clock cycles in which instructions A to G are eventually placed.

The following explains each decision in detail.

(First Decision) Since instruction A that has no predecessor with which it has a dependency is the only placeable instruction at this stage, the instruction scheduling unit 130 generates a placeable instruction list {A}.

The resource constraint evaluation unit 152 calculates a resource constraint value of instruction A. Instruction A is an instruction to be processed by the memory access unit. At this stage, there are four unplaced instructions, namely, instructions A, E, F, and G, which are to be processed by the memory access unit. The resource constraint evaluation unit 152 divides this number 4 by 1 which is the maximum number of instructions that can be processed in parallel by the memory access unit. The resource constraint evaluation unit 152 sets the result 4 as the resource constraint value of instruction A.

This resource constraint value of instruction A is larger than the precedence constraint rank of instruction A. Accordingly, a priority of instruction A is set at 4.

The instruction selection unit 161 selects instruction A. The execution timing decision unit 160 places instruction A in clock cycle 1.

(Second Decision) Once instruction A has been placed, instructions B, C, and E become placeable. Accordingly, the instruction scheduling unit 130 generates a placeable instruction list {B, C, E}.

The resource constraint evaluation unit 152 calculates a resource constraint value of instruction B. Instruction B is an instruction to be processed by the arithmetic units. At this stage, there are three unplaced instructions, namely, instructions B, C, and D, that are to be processed by the arithmetic units. The resource constraint evaluation unit 152 divides this number 3 by 2 which is the maximum number of instructions that can be processed in parallel by the arithmetic units. The resource constraint evaluation unit 152 sets the result 1.5 as the resource constraint value of instruction B.

Since this resource constraint value of instruction B is no larger than the precedence constraint rank of instruction B, a priority of instruction B is set at 2.

The resource constraint evaluation unit 152 calculates a priority of instruction C at 2, in the same way as instruction B.

The resource constraint evaluation unit 152 also calculates a resource constraint value of instruction E. Instruction E is an instruction to be processed by the memory access unit. At this stage, there are three unplaced instructions, namely, instructions E, F, and G, that are to be processed by the memory access unit. The resource constraint evaluation unit 152 divides this number 3 by 1 which is the maximum number of instructions that can be processed in parallel by the memory access unit. The resource constraint evaluation unit 152 sets the result 3 as the resource constraint value of instruction E.

Since this resource constraint value of instruction E is larger than the precedence constraint rank of instruction E, a priority of instruction E is set at 3.

The instruction selection unit 161 selects instruction E having a highest priority. The execution timing decision unit 160 places instruction E in clock cycle 2 that is an earliest clock cycle after clock cycle 1 in which instruction A is placed.

(Third Decision) Once instructions A and E have been placed, instructions B, C, and F which have instructions A and E as predecessors become placeable. Accordingly, the instruction scheduling unit 130 generates a placeable instruction list {B, C, F}.

The resource constraint evaluation unit 152 calculates a priority of each of instructions B and C at 2, in the same way as in the second decision.

The resource constraint evaluation unit 152 also calculates a resource constraint value of instruction F at 2. Since this resource constraint value of instruction F is larger than the precedence constraint rank of instruction F, a priority of instruction F is set at 2.

Since instructions B, C, and F have the same priority, the instruction selection unit 161 selects instruction B according to an order in which instructions A to G are described in the original program. The execution timing decision unit 160 places instruction B in an earliest clock cycle after clock cycle 1 in which instruction A is placed. Instruction B can be executed in the target processor in parallel with instruction E which is placed in clock cycle 2, without exceeding the maximum number of parallel-processable instructions of each component in the target processor. Therefore, the execution timing decision unit 160 places instruction B in clock cycle 2.

(Fourth Decision) The remaining decisions are explained more briefly. The instruction scheduling unit 130 generates a placeable instruction list {C, F}. The resource constraint evaluation unit 152 calculates resource constraint values of instructions C and F at 1 and 2 respectively. The priority calculation unit 150 sets priorities of instructions C and F both at 2.

The instruction selection unit 161 selects instruction C, according to the description order of the original program. The execution timing decision unit 160 places instruction C in clock cycle 3.

(Fifth Decision) The instruction scheduling unit 130 generates a placeable instruction list {D, F}. The resource constraint evaluation unit 152 calculates resource constraint values of instructions D and F at 0.5 and 2 respectively. The priority calculation unit 150 sets priorities of instructions D and F at 1 and 2 respectively.

The instruction selection unit 161 selects instruction F. The execution timing decision unit 160 places instruction F in clock cycle 3.

(Sixth Decision) The instruction scheduling unit 130 generates a placeable instruction list {D, G}. The resource constraint evaluation unit 152 calculates resource constraint values of instructions D and G at 0.5 and 1 respectively. The priority calculation unit 150 sets priorities of instructions D and G both at 1.

The instruction selection unit 151 selects instruction D, according to the description order of the original program. The execution timing decision unit 160 places instruction D in clock cycle 4.

(Seventh Decision) The instruction scheduling unit 130 generates a placeable instruction list {G}. The priority calculation unit 150 sets a priority of instruction G at 1.

The instruction selection unit 161 selects instruction G. The execution timing decision unit 160 places instruction G in clock cycle 4.

As a result, instructions A to G are placed in the clock cycles in the same fashion as in the first embodiment (see FIG. 5).

### Conclusion

As described above, the instruction scheduling device of the second embodiment sets, for each placeable instruction, a larger one of a resource constraint value and a precedence constraint rank as a priority. The instruction scheduling device then selects an instruction having a highest priority and places the selected instruction in a clock cycle. This is repeated until all instructions are placed in clock cycles.

Thus, an instruction having a strict resource constraint is placed in an earlier clock cycle than in the conventional technique. This makes it possible to place a plurality of instructions including such a strict resource-constraint instruction in fewer clock cycles than in the conventional technique.

In particular, the instruction scheduling device of the second embodiment has the following effect. Suppose there are many unplaced instructions that are to be processed by a hardware resource which is capable of processing only a small number of instructions in parallel, with there being no dependencies between the instructions. This being so, high resource constraint values are calculated for these instructions. This produces a specific effect of appropriately placing such instructions in earlier clock cycles. The instruction scheduling device of the first embodiment raises a priority of an instruction according to a resource constraint only when the instruction has a dependency with another instruction, and so does not have such a specific effect.

### Third Embodiment

An instruction scheduling device of the third embodiment of the present invention receives an input of a plurality of instructions that are subjected to scheduling, and calculates a precedence constraint rank of each instruction. After this, the instruction scheduling device repeats the following procedure so as to place the instructions in a desired number of clock cycles.

The instruction scheduling device selects an instruction having a highest precedence constraint rank from placeable instructions, and places the selected instruction in a clock cycle. The instruction scheduling device then calculates, for each placeable instruction, a number of remaining clock cycles in which the instruction can be placed and a resource constraint value of the instruction. The instruction scheduling device compares the number of remaining clock cycles and the resource constraint value, to judge whether all instructions can be placed in the desired number of clock cycles.

If the judgment is in the negative, the instruction scheduling device retracts the immediately preceding placement of the instruction, and removes the instruction from the placeable instructions. The instruction scheduling device then places one of the placeable instructions in a clock cycle.

Thus, the instruction scheduling device of the third embodiment differs from that of the second embodiment in that resource constraint values are used to judge whether all instructions can be placed in a desired number of clock cycles and, if the judgment is in the negative, the immediately preceding placement is retracted and another instruction is placed.

The following explanation mainly focuses on this difference from the second embodiment, while omitting the same features as those of the second embodiment.

### Overall Construction

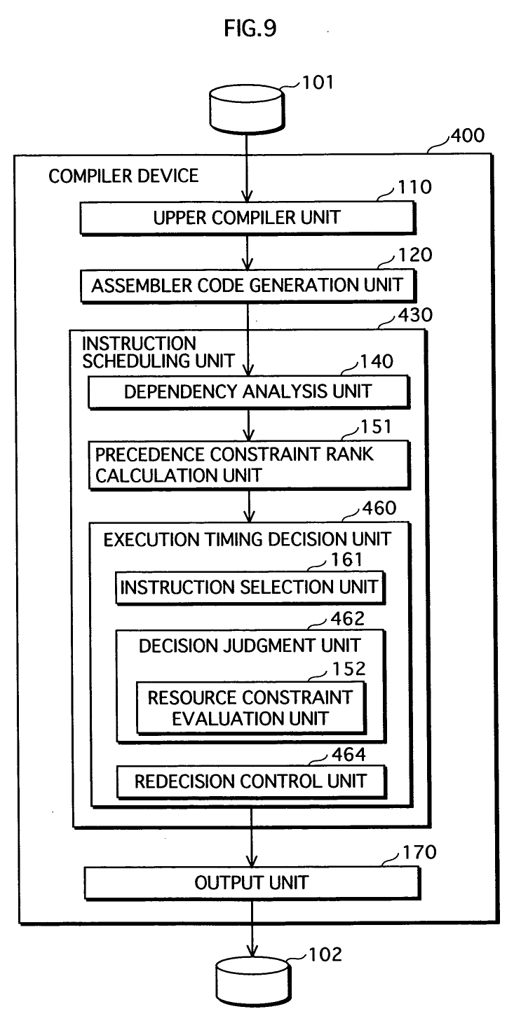

FIG. 9 is a functional block diagram showing an overall construction of a compiler device 400 to which the third embodiment relates. The compiler device 400 includes the instruction scheduling device of the third embodiment as an instruction scheduling unit 430.

Like the compiler device 100, the compiler device 400 generates an object program optimized for parallel processing from a source program held in the source file 101, and outputs the object program to the object file 102.

In the compiler device 400 shown in FIG. 9, the same components as those of the compiler device 100 in the first embodiment shown in FIG. 1 have been given the same reference numerals.

The compiler device 400 includes the upper compiler unit 110, the assembler code generation unit 120, the instruction scheduling unit 430, and the output unit 170. The instruction scheduling unit 430 includes the dependency analysis unit 140, the precedence constraint rank calculation unit 151, and an execution timing decision unit 460. The execution timing decision unit 460 includes the instruction selection unit 161, a decision judgment unit 462, and a redecision control unit 464. The decision judgment unit 462 includes the resource constraint evaluation unit 152.

The compiler device 400 is actually realized by software and hardware including a processor,a ROM storing a program, a working RAM, and a disk device. The functions of the individual components of the compiler device 400 are achieved by the processor executing the program stored in the ROM. Data transfers between the components are carried out through hardware such as the RAM and the disk device.

The upper compiler unit 110, the assembler code generation unit 120, and the output unit 170 are the same as those of the first embodiment and so their explanation has been omitted here. The following explains the instruction scheduling unit 430.

### Instruction Scheduling Unit 430

The instruction scheduling unit 430 in the third embodiment is explained in detail below, with reference to a flowchart.

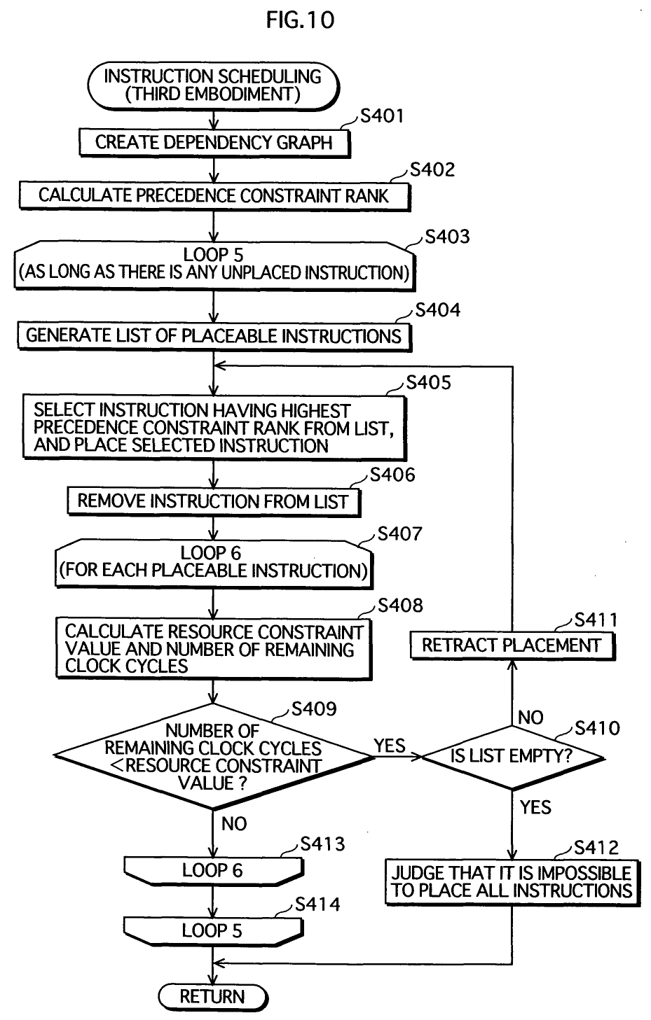

FIG. 10 is a flowchart showing an instruction scheduling procedure in the third embodiment.

(Step S401) The dependency analysis unit 140 creates a dependency graph showing dependencies between instructions included in an assembler code string which is generated by the assembler code generation unit 120.

(Steep S402) The precedence constraint rank calculation unit 151 assigns weights 1, 0, and 0 respectively to arcs representing data dependency, anti-dependency, and output dependency in the dependency graph created by the dependency analysis unit 140. The precedence constraint rank calculation unit 151 then adds up weights to calculate precedence constraint ranks.

(Step S403) Steps S404 to S414 are repeated as long as there is an unplaced instruction (loop 5).

(Step S404) The instruction scheduling unit 430 generates a list of placeable instructions. A placeable instruction is an instruction that satisfies one of the following conditions (a) and (b).

(a) The instruction has no predecessor with which it has a dependency.

(b) The instruction has one or more predecessors with which it has a dependency, but all of these predecessors have already been placed in clock cycles.

(Step S405) The instruction selection unit 161 selects an instruction having a highest precedence constraint rank from the list. The execution timing decision unit 460 places the selected instruction in a clock cycle that meets the following two conditions (1) and (2).

(1) The clock cycle is the same as or later than a clock cycle in that a predecessor with which the instruction has anti-dependency or output dependency is placed, and is later than a clock cycle in that a predecessor with which the instruction has data dependency is placed.

(2) The clock cycle is an earliest clock cycle in that a hardware resource can process the instruction.

(Step S406) The instruction scheduling unit 430 removes the instruction from the list.

(Step S407) Steps S408 to S413 are repeated for each placeable instruction, including an instruction that becomes placeable as a result of step S405 (loop 6).

(Step S408) The resource constraint evaluation unit 152 calculates a resource constraint value of the instruction. The resource constraint value is obtained by dividing a number of unplaced instructions that are to be processed by a hardware resource for processing the instruction, by a maximum number of instructions that can be processed in parallel by the hardware resource.

The decision judgment unit 462 calculates a number of remaining clock cycles in which the instruction can be placed. This calculation is performed using a maximum number of instructions (hereafter referred to as a “common maximum number”) that can be processed in parallel in one clock cycle by a resource (e.g. the instruction decoders) which is commonly needed for processing of any instruction in the target processor. In the case of the processor 800 shown in FIG. 2, the common maximum number is 2.

The number of remaining clock cycles is obtained by counting clock cycles, among the desired number of clock cycles, that each meet the following two conditions (i) and (ii).

(i) The clock cycle is the same as or later than a clock cycle in that a predecessor with which the instruction has anti-dependency or output dependency is placed, and is later than a clock cycle in that a predecessor with which the instruction has data dependency is placed.

(ii) The clock cycle has a smaller number of placed instructions than the common maximum number.

(Step S409) If the resource constraint value is larger than the number of remaining clock cycles, the procedure advances to step S410. Otherwise, the procedure advances to step S413.

(Step S410) If the list is empty, the procedure advances to step S412. Otherwise, the procedure advances to step S411.

(Step S411) The redecision control unit 464 retracts the placement made in step S405. After this, the procedure returns to step S405 to place another instruction.

(Step S412) The instruction scheduling unit 430 judges that it is impossible to place all instructions in the desired number of clock cycles, and terminates the procedure.

(Step S413) The procedure returns to step S407.

(Step S414) The procedure returns to step S403.

### SPECIFIC EXAMPLE

Take once again the program shown in FIG. 15 as an example, with the desired number of clock cycles being set at 4. The dependency analysis unit 140 creates a dependency graph which is identical to the conventional dependency graph shown in FIG. 16. The precedence constraint rank calculation unit 151 calculates precedence constraint ranks from the dependency graph.

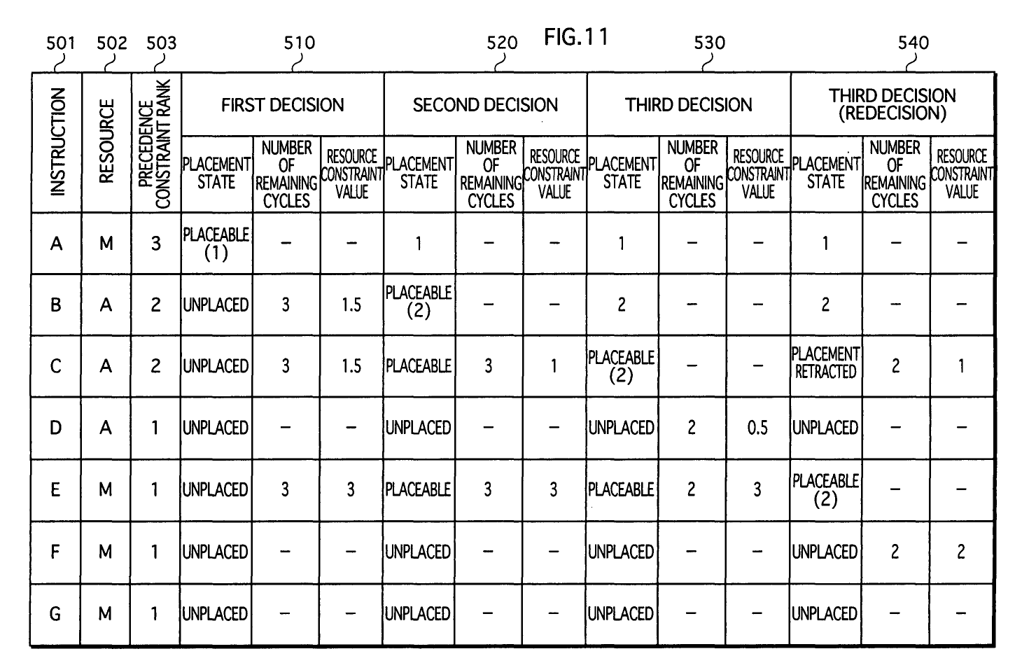

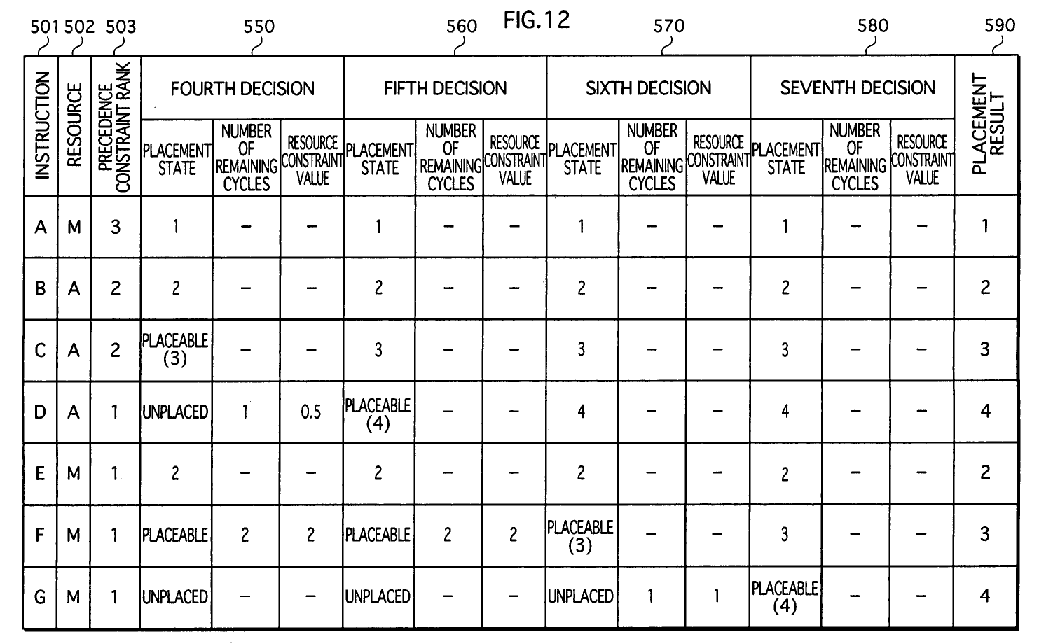

FIGS. 11 and 12 show a process of placing each of instructions A to G by the instruction scheduling unit 430.

In the drawing, an instruction field 501 shows an instruction by a letter symbol. A resource field 502 shows M when the instruction is to be processed by the memory access unit, and A when the instruction is to be processed by the arithmetic units. A precedence constraint rank field 503 shows a precedence constraint rank of the instruction.

First to seventh decision fields 510 to 580 each show a placement state, a number of remaining clock cycles, and a resource constraint value of the instruction, in an order in which execution timings of instructions A to G are decided. The placement state field has three states. When the instruction is unplaced and is not placeable, the placement state field shows “unplaced”. When the instruction is unplaced and placeable, the placement state field shows “placeable”. When the instruction has already been placed, the placement state field shows a cycle number of a clock cycle in which the instruction is placed. In addition, the placement state field shows a cycle number, in parentheses, of a clock cycle in which one placeable instruction is newly placed.

A placement result field 590 shows cycle numbers of clock cycles in which instructions A to G are eventually placed.

Each decision is explained in detail below.

(First Decision) Since instruction A that has no predecessor with which it has a dependency is the only placeable instruction at this stage, the instruction scheduling unit 430 generates a placeable instruction list {A}. The instruction selection unit 161 selects instruction A. The execution timing decision unit 460 places instruction A in clock cycle 1. The instruction scheduling unit 430 removes instruction A from the list.

Once instruction A has been placed, three instructions B, C, and E become placeable. Instructions B and C are to be processed by the arithmetic units, whereas instruction E is to be processed by the memory access unit. At this stage, there are three unplaced instructions, namely, instructions B, C, and D, that are to be processed by the arithmetic units. Meanwhile, there are three unplaced instructions, namely, instructions E, F, and G, that are to be processed by the memory access unit.

The resource constraint evaluation unit 152 calculates a resource constraint value of instruction B at 1.5, by dividing 3 which is the number of unplaced instructions to be processed by the arithmetic units by 2 which is the maximum number of instructions that can be processed in parallel by the arithmetic units.

Also, the decision judgment unit 462 calculates a number of remaining clock cycles for instruction B at 3, as there are three clock cycles 2, 3, and 4 that are later than clock cycle 1 in which instruction A having data dependency with instruction B is placed and that each have a smaller number of placed instructions than the common maximum number.

Likewise, the resource constraint evaluation unit 152 calculates a resource constraint value of instruction C at 1.5, and the decision judgment unit 462 calculates a number of remaining clock cycles for instruction C at 3.

Also, the resource constraint evaluation unit 152 calculates a resource constraint value of instruction E at 3, by dividing 3 which is the number of unplaced instructions to be processed by the memory access unit by 1 which is the maximum number of instructions that can be processed in parallel by the memory access unit.

The decision judgment unit 462 calculates a number of remaining clock cycles for instruction E at 3, as there are three clock cycles 2, 3, and 4 that are later than clock cycle 1 in which instruction A having data dependency with instruction E is placed and that each have a smaller number of placed instructions than the common maximum number.

Since the resource constraint value is no higher than the number of remaining clock cycles for each of instructions B, C, and E, the process proceeds to the second decision.

(Second Decision) In the second decision, instruction B is placed in clock cycle 2. After this, a resource constraint value and a number of remaining clock cycles are calculated for each of placeable instructions C and E again. Since the resource constraint value is no higher than the number of remaining clock cycles for each of instructions C and E, the process proceeds to the third decision.

(Third Decision) Since instructions C and E whose predecessors have all been placed are placeable instructions, the instruction scheduling unit 430 generates a placeable instruction list {C, E}. The instruction selection unit 161 selects instruction C. The execution timing decision unit 460 places instruction C in clock cycle 2. The instruction scheduling unit 430 removes instruction C from the list.

Once instruction C has been placed, there are two placeable instructions D and E. Instruction D is to be processed by the arithmetic units, whereas instruction E is to be processed by the memory access unit. At this stage, there is only one unplaced instruction, namely, instruction D, that is to be processed by the arithmetic units. Meanwhile, there are three unplaced instructions, namely, instructions E, F, and G, that are to be processed by the memory access unit.

The resource constraint evaluation unit 152 calculates a resource constraint value of instruction D at 0.5, by dividing 1 which is the number of unplaced instructions to be processed by the arithmetic units by 2 which is the maximum number of instructions that can be processed in parallel by the arithmetic units.

The decision judgment unit 462 calculates a number of remaining clock cycles for instruction D at 2, as there are two clock cycles 3 and 4 that are later than clock cycle 2 in which instruction C having data dependency with instruction D is placed and that each have a smaller number of placed instructions than the common maximum number.

Also, the resource constraint evaluation unit 152 calculates a resource constraint value of instruction E at 3, by dividing 3 which is the number of unplaced instructions to be processed by the memory access unit by 1 which is the maximum number of instructions that can be processed in parallel by the memory access unit.

The decision judgment unit 462 calculates a number of remaining clock cycles for instruction E at 2, as there are two clock cycles 3 and 4 that are later than clock cycle 1 in which instruction A having data dependency with instruction E is placed and that each have a smaller number of placed instructions than the common maximum number.

Since the resource constraint value of instruction E is higher than the number of remaining clock cycles of instruction E, the redecision control unit 464 retracts the placement of instruction C and places another instruction.

(Third Decision—Retry) In the retry of the third decision, the placeable instruction list is {E}. Accordingly, instruction E is selected and placed in clock cycle 2.

Once instruction E has been placed, there are two placeable instructions, namely, instruction F and instruction C whose placement has been retracted. Instruction C is to be processed by the arithmetic units, whereas instruction F is to be processed by the memory access unit. At this stage, there are two unplaced instructions, namely, instructions C and D, that are to be processed by the arithmetic units. Meanwhile, there are two unplaced instructions, namely, instructions F and G, that are to be processed by the memory access unit.

The resource constraint evaluation unit 152 calculates a resource constraint value of instruction C at 1. The decision judgment unit 462 calculates a number of remaining clock cycles of instruction C at 2.

Also, the resource constraint evaluation unit 152 calculates a resource constraint value of instruction F at 2. The decision judgment unit 462 calculates a number of remaining clock cycles of instruction F at 2.

Since the resource constraint value is no higher than the number of remaining clock cycles for each of instructions C and F, the process proceeds to the fourth decision.

(Fourth to Seventh Decisions) No retry occurs in the fourth to seventh decisions, as shown in FIG. 12.

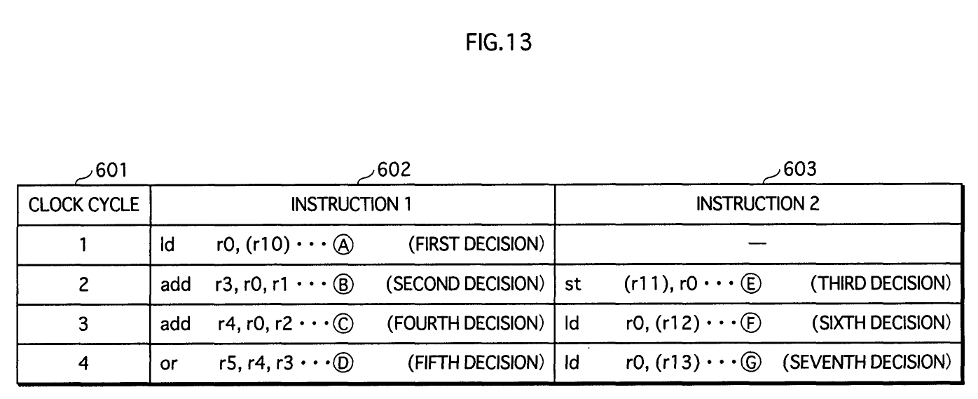

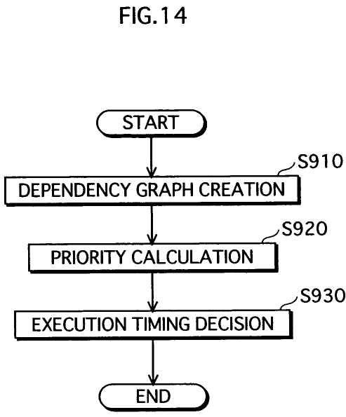

FIG. 13 shows instructions A to G which are placed as a result of the above process. As illustrated, all instructions A to G are successfully placed within 4 clock cycles.

In the third embodiment, these instructions are placed in the clock cycles in the same fashion as in the first and second embodiments, though the order of decisions is partially different (see FIG. 5).

### Conclusion

As described above, the instruction scheduling device of the third embodiment tries to place instructions within a desired number of clock cycles. The instruction scheduling device places instructions according to precedence constraint ranks. Each time one instruction is placed, the instruction scheduling device judges whether all instructions can be placed in the desired number of clock cycles, in consideration of resource constraints. If the judgment is in the negative, the instruction scheduling device retracts the immediately preceding placement and places another instruction.

Thus, the instruction scheduling device judges whether all instructions can be placed within the desired number of clock cycles in consideration of resource constraints. In accordance with the result of this judgment, the instruction scheduling device controls a retry of placement. This contributes to a greater chance of placing a plurality of instructions including strict resource-constraint instructions in a desired number of clock cycles, when compared with the case where the same judgment is made in consideration of only dependencies between instructions.

### Modifications

The present invention has been described by way of the above embodiments, though it should be obvious that the invention is not limited to the above. Example modifications are given below.

(1) The methods of the invention including the steps described in the above embodiments may be realized by a computer program that is executed by a computer system. Such a computer program may be distributed as a digital signal.

The invention may also be realized by a computer-readable storage medium, such as a flexible disk, a hard disk, a CD-ROM, an MO (Magneto-Optical) disc, a DVD (Digital Versatile Disc), a DVD-ROM, a DVD-RAM, or a semiconductor memory, on which the computer program or digital signal mentioned above is recorded.

The computer program or digital signal that achieves the invention may also be transmitted via a network, such as an electronic communications network, a wired or wireless communications network, or the Internet.

The invention can also be realized by a computer system that includes a microprocessor and a memory. In this case, the computer program can be stored in the memory, with the microprocessor operating in accordance with this computer program to achieve the invention.

The computer program or digital signal may be provided to an independent computer system by distributing a storage medium on which the computer program or digital signal is recorded, or by transmitting the computer program or digital signal via a network. The independent computer system may then execute the computer program or digital signal to function as the invention.

(2) The example program (FIG. 15) used in the above embodiments may be a whole program compiled from a source program prior to optimization for parallel processing, or a basic block of such a program.

(3) The third embodiment describes the case where when the placement of an instruction in the placeable instruction list is retracted in step S411, the procedure returns to step S405 to place another instruction in the placeable instruction list. If the placement of every instruction in the placeable instruction list fails, it is judged in step S412 that the instructions cannot be placed within the desired number of clock cycles.

This can be modified as follows. A placeable instruction list generated in step S404 in the past is retained. If the placement of every instruction in the present placeable instruction list fails, instead of instantly judging that the instructions cannot be placed within the desired number of clock cycles, the placement of an instruction in the past placeable instruction list is retracted and another instruction in the past placeable instruction list is placed.

This can be easily carried out according to a conventionally used backtracking algorithm.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. An instruction scheduling method comprising:
a priority calculation step of calculating a priority of each of a plurality of instructions that are subjected to scheduling, based on dependencies between the plurality of instructions and constraints of hardware resources for processing the plurality of instructions, the dependencies being data dependency, anti-dependency, and output dependency; and
an execution timing decision step of deciding an execution timing of an instruction having a highest priority.

2. The instruction scheduling method of claim 1,
wherein the priority calculation step includes:
a precedence constraint rank calculation substep of calculating a precedence constraint rank of each of the plurality of instructions, wherein (a) if the instruction has a succeeding instruction which is anti-dependent or output dependent on the instruction, the precedence constraint rank of the instruction is equal to a precedence constraint rank of the succeeding instruction, and (b) if the instruction has a succeeding instruction which is data dependent on the instruction, the precedence constraint rank of the instruction is higher than a precedence constraint rank of the succeeding instruction; and
a resource constraint evaluation substep of judging (i) whether the instruction has a succeeding instruction which is dependent on the instruction, (ii) whether the instruction and the succeeding instruction have an equal precedence constraint rank, and (iii) whether a hardware resource for processing the instruction cannot process the instruction and the succeeding instruction in parallel, and
the priority calculation step raises the precedence constraint rank of the instruction and sets the raised precedence constraint rank as a priority of the instruction if all of the judgments (i), (ii), and (iii) are in the affirmative, and sets the precedence constraint rank of the instruction as the priority of the instruction if any of the judgments (i), (ii), and (iii) is in the negative.

3. The instruction scheduling method of claim 1,
wherein the priority calculation step includes:
a precedence constraint rank calculation substep of calculating a precedence constraint rank of each of the plurality of instructions, wherein (a) if the instruction has no succeeding instruction which is dependent on the instruction, the precedence constraint rank of the instruction is 1, (b) if the instruction has one or more succeeding instructions which are anti-dependent or output dependent on the instruction, the precedence constraint rank of the instruction is a highest one of precedence constraint ranks of the succeeding instructions, and (c) if the instruction has one or more succeeding instructions which are data dependent on the instruction, the precedence constraint rank of the instruction is a sum of 1 and a highest one of precedence constraint ranks of the succeeding instructions; and
a resource constraint evaluation substep of calculating a resource constraint value of the instruction, by dividing a total number of instructions which are to be processed by a hardware resource for processing the instruction and whose execution timings have not been decided, by a maximum number of instructions that can be processed in parallel by the hardware resource, and
the priority calculation step sets the resource constraint value as a priority of the instruction if the resource constraint value is larger than the precedence constraint rank, and sets the precedence constraint rank as the priority of the instruction if the resource constraint value is no larger than the precedence constraint rank.

4. An instruction scheduling method for sequentially deciding execution timings of instructions that are subjected to scheduling, comprising:
a decision judgment step of judging, after an execution timing of a first instruction is decided, whether an execution timing of a second instruction can be decided so as to be within a predetermined time period, based on a constraint of a hardware resource for processing the second instruction; and
a redecision step of retracting, if the judgment is in the negative, the decision of the execution timing of the first instruction and deciding an execution timing of an instruction other than the first instruction.

5. The instruction scheduling method of claim 4,
wherein the predetermined time period is expressed by a number of clock cycles,
the decision judgment step includes:
a resource constraint evaluation substep of calculating a resource constraint value of the second instruction, by dividing a total number of instructions which are to be processed by the hardware resource and whose execution timings have not been decided, by a maximum number of instructions that can be processed in parallel by the hardware resource, and
the decision judgment step judges in the negative if the resource constraint value is larger than the number of clock cycles.

6. A program conversion method characterized in that:
an input program is converted to an object program including a plurality of instructions, and an execution timing of each of the plurality of instructions in the object program is decided using the instruction scheduling method of one of claims 1 to 5.

7. An instruction scheduling device comprising:
a priority calculation unit operable to calculate a priority of each of a plurality of instructions that are subjected to scheduling, based on dependencies between the plurality of instructions and constraints of hardware resources for processing the plurality of instructions, the dependencies being data dependency, anti-dependency, and output dependency; and
an execution timing decision unit operable to decide an execution timing of an instruction having a highest priority.

8. An instruction scheduling device for sequentially deciding execution timings of instructions that are subjected to scheduling, comprising:
a decision judgment unit operable to judge, after an execution timing of a first instruction is decided, whether an execution timing of a second instruction can be decided so as to be within a predetermined time period, based on a constraint of a hardware resource for processing the second instruction; and
a redecision unit operable to retract, if the judgment is in the negative, the decision of the execution timing of the first instruction and decide an execution timing of an instruction other than the first instruction.

9. A computer-executable program for instruction scheduling, having a computer execute:
a priority calculation step of calculating a priority of each of a plurality of instructions that are subjected to scheduling, based on dependencies between the plurality of instructions and constraints of hardware resources for processing the plurality of instructions, the dependencies being data dependency, anti-dependency, and output dependency; and
an execution timing decision step of deciding an execution timing of an instruction having a highest priority.

10. A computer-executable program for sequentially deciding execution timings of instructions that are subjected to scheduling, having a computer execute:
a decision judgment step of judging, after an execution timing of a first instruction is decided, whether an execution timing of a second instruction can be decided so as to be within a predetermined time period, based on a constraint of a hardware resource for processing the second instruction; and
a redecision step of retracting, if the judgment is in the negative, the decision of the execution timing of the first instruction and deciding an execution timing of an instruction other than the first instruction.

11. A computer-readable storage medium storing the program of one of claims 9 and 10.
